(19) United States
(12) Patent Application Publication
(10) Pub. No.: US 2024/0169164 A1
(43) Pub. Date: May 23, 2024

(54) TOPICAL EVENT ANALYSIS TO AUTO-GENERATE PHRASES AND EFFECTS

(71) Applicant: Meta Platforms, Inc., Menlo Park, CA (US)

(72) Inventor: Giridhar RAJARAM, Saratoga, CA (US)

(73) Assignee: Meta Platforms, Inc., Menlo Park, CA (US)

(21) Appl. No.: 18/056,507

(22) Filed: Nov. 17, 2022

(51) Int. Cl. G06F 40/56; G06F 40/30; H04L 51/52

(52) U.S. Cl. CPC G06F 40/56; G06F 40/30; H04L 51/52

(57) ABSTRACT

Systems, apparatuses and methods provide technology that identifies historical data for a first user, where the historical data identifies previous posts by the first user. The technology identifying an event. The technology determines an affinity score for the first user based on the historical data and the event, determines whether the affinity score meets a threshold, and if the affinity score meets the threshold, determines one or more of a phrase or an effect to present to the first user.

### TECHNICAL FIELD

Examples of the disclosure generally relate to phrase and/or effect generation. More particularly, examples relate to determining a relevant event for a user, generating a personalized phrase for the event, and providing the personalized phrase to the user to facilitate focused, timely and insightful commentaries.

### BACKGROUND

Users may be passionate about events (e.g., social events, local events, national events, etc.) that occur on a regular or semi-regular basis. While users may feel passionate about such events, such users may have difficulty expressing such passions. For example, articulating and drafting comments related to an event may be time consuming and cause a user to bypass commenting altogether. Moreover, some users may inadvertently neglect to comment on such relevant events.

### SUMMARY

Some examples include at least one computer readable storage medium comprising a set of instructions, which when executed by a computing device, cause the computing device to identify a historical data for a first user, wherein the historical data identifies previous posts by the first user, identify an event, determine an affinity score for the first user based on the historical data and the event, determine whether the affinity score meets a threshold, and if the affinity score meets the threshold, determine one or more of a phrase or an effect to present to the first user.

Some examples include a system comprising one or more processors. The system includes a memory coupled to the one or more processors. The memory comprises instructions executable by the one or more processors. The one or more processors being operable when executing the instructions to identify a historical data for a first user, wherein the historical data identifies previous posts by the first user, identify an event, determine an affinity score for the first user based on the historical data and the event, determine whether the affinity score meets a threshold, and if the affinity score meets the threshold, determine one or more of a phrase or an effect to present to the first user.

Some examples include a method comprising identifying a historical data for a first user, where the historical data identifies previous posts by the first user. Such examples include identifying an event, determining an affinity score for the first user based on the historical data and the event, determining whether the affinity score meets a threshold, and if the affinity score meets the threshold, determining one or more of a phrase or an effect to present to the first user.

### BRIEF DESCRIPTION OF THE DRAWINGS

The various advantages of the examples will become apparent to one skilled in the art by reading the following specification and appended claims, and by referencing the following drawings, in which:

FIG. 1 is an example of a phrase and effect generation architecture according to an example of the disclosure;

FIG. 2 is a pre-generated phrase and event database according to an example of the disclosure;

FIG. 3 is an example of a method of identifying events of interest according to an example of the disclosure;

FIG. 4 is an example of a method of generating phrases and effects based on whether an event is an anticipated event, partially anticipated event or unanticipated event according to an example of the disclosure;

FIG. 5 is an example of a method of determining whether to generate personalized comments based on an affinity score according to an example of the disclosure;

FIG. 6 is an example of a method of propagating user inputs to users according to an example of the disclosure;

FIG. 7 is an example of a method of determining when to generate or bypass personalized text and/or effect according to an example of the disclosure;

FIGS. 8A-8B are examples of a conventional graphical user interface and enhanced graphical user interfaces according to an example of the disclosure;

FIG. 9 is an example of a method of generating phrases and/or effects according to an example of the disclosure;

FIG. 10 illustrates an example network environment associated with a social-networking system according to an example of the disclosure;

FIG. 11 illustrates an example social graph according to an example of the disclosure; and

FIG. 12 illustrates an example computer system according to an example of the disclosure.

### DESCRIPTION EXAMPLE

Examples of the disclosure relate to facilitating content creation in an efficient and focused manner. In detail, examples herein may identify an event, analyze the event and user history to determine whether a phrase and/or effect should be generated, and correspondingly generate the phrase and/or the effect. That is, some examples may determine important events that engage a particular user (e.g., sports team winning a league championship, Father's Day, Independence Day etc.) and generate phrases and/or effects for the important events to cause the particular user to engage with and comment on the important events. Thus, examples boost original content creation based on trending events.

Examples as described herein may identify phrases and/or effects (e.g., music, photographs, memes, videos, “stickers,” etc.) based on a specific profile of a user, and an event. For example, to facilitate the user posting about a specific event, examples as described herein may generate a message (e.g., a verbal expression, visual expression and/or audio expression) to capture a sentiment of the user with respect to the specific event and incorporate the user's lexicon, preferred writing style, grammar, etc. Doing so enables a user to quickly adjust the message if so desired, approve and propagate the message (or a modified version of the message). Furthermore, some examples may identify when such message generation (e.g., phrase generation) is desirable, or is undesirable and bypassed so as to efficiently utilize processing power and resources.

In order to generate a message, examples identify a historical data for a first user, where the historical data identifies previous posts by the first user, identify an event, determine an affinity score for the first user based on the historical data and the event, determine whether the affinity score meets a threshold, and if the affinity score meets the threshold, determine a phrase to present to the first user. The affinity score may represent a strength of a relationship or level of interest between particular objects associated with the online social network, which in this example is the first user and the event.

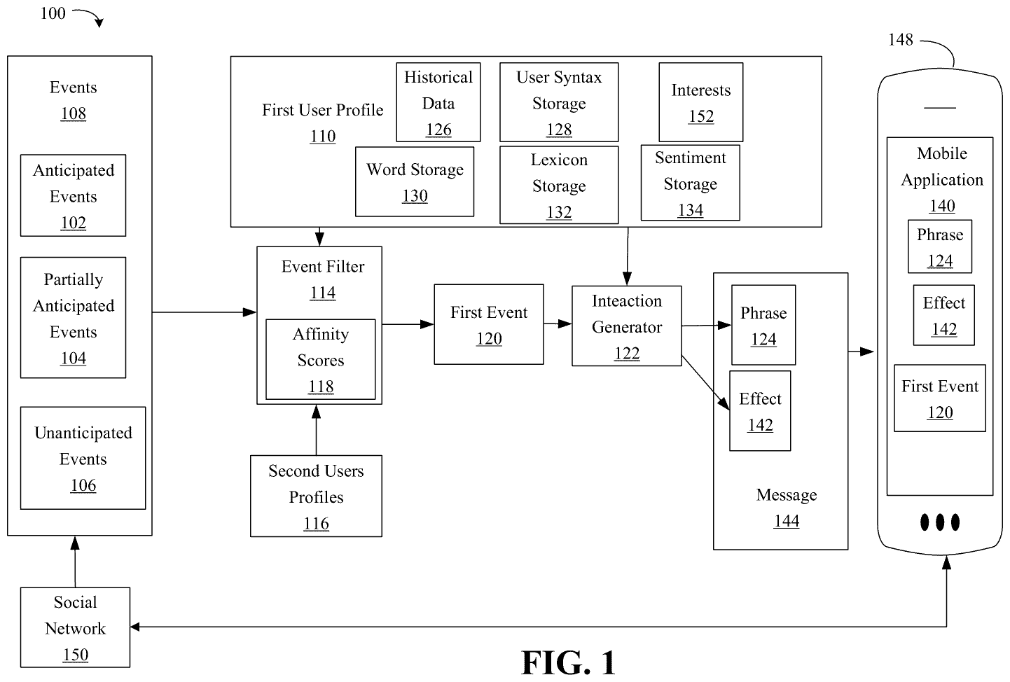

Turning now to FIG. 1, a phrase and effect generation architecture 100 is illustrated. The phrase and effect generation architecture 100 may be a computing architecture. For example, the phrase and effect generation architecture 100 may be implemented in a computing device including a memory and processor, computing system (e.g., hardware, configurable logic, fixed-function logic hardware, at least one computer readable storage medium comprising a set of instructions for execution, etc.). Any and all components of the phrase and effect generation architecture 100 may be implemented as a computing device, non-transitory computer readable storage medium, server, mobile device, etc.

In this example, events 108 are identified by the phrase and effect generation architecture 100. The events 108 comprise anticipated events 102, partially anticipated events 104 and unanticipated events 106. The anticipated events 102 includes an event where the outcome and expected progression is known. Some examples of the anticipated events 102 include events such as national holidays (e.g., Independence Day), religious holidays (e.g., Christmas), special occasions (e.g., Mother's Day) whose dates are already known in advance, the progression is generally understood and the outcome is generally known (e.g., celebrate the respective event).

Partially anticipated events 104 are events which will occur on a specific and known date and/or time, but an outcome and/or progression is unknown (e.g., sports events finals). Examples of partially anticipated events 104 include athletic games (e.g., sports finals) will be scheduled to occur on certain dates and times, but the outcome and progression of events during the game(s) are unknown until the game(s) are played and completed. So a topical event (e.g., National Basketball Association™ finals) is anticipated and a topical event (e.g., “Team Skyhook beats Team Layup to win the basketball finals” or “Team Layup beats Team Skyhook to win the basketball finals”) is partially anticipated. Thus, a partially anticipated event has a set date and time, but without a known progression and fixed outcome (e.g., multiple outcomes may occur).

Unanticipated events 106 are events that happen without any previous notice and are unexpected. Examples of unanticipated events 106 include events associated with public figures, natural disasters etc. Such unanticipated events 106 may have no set date and time, and the progression as well as the outcome may be unknown.

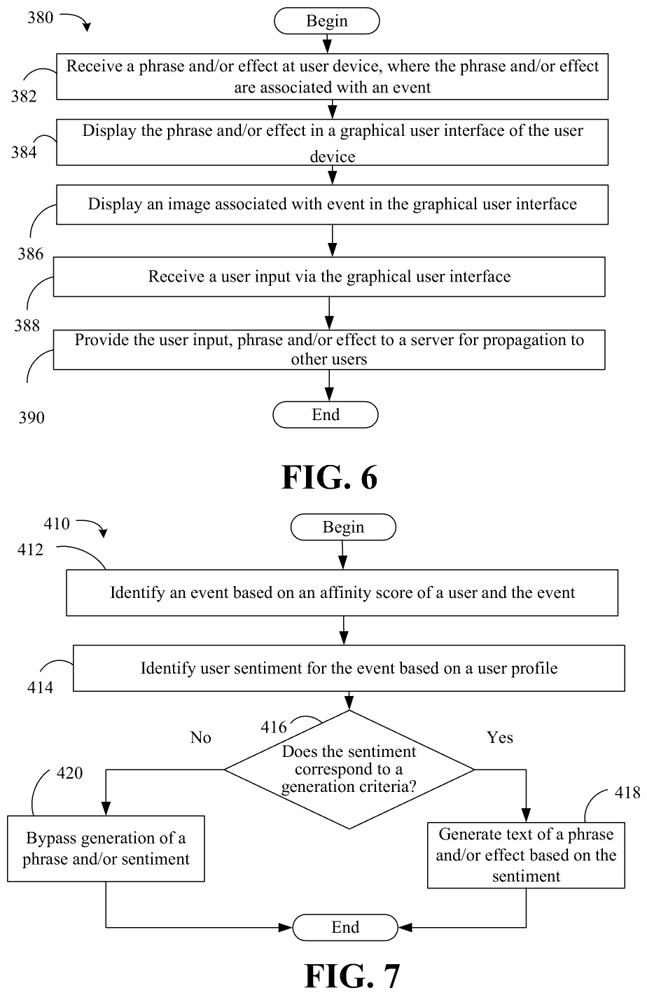

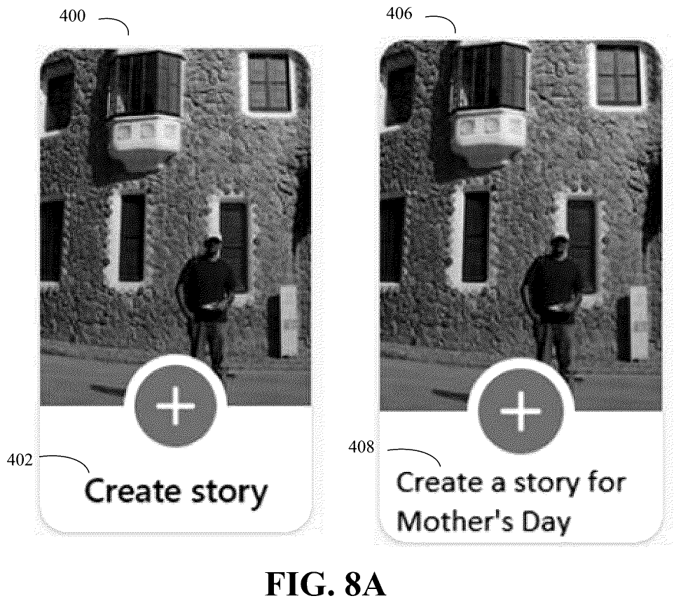

The events 108 may be identified and selected based on various criteria. For example, the phrase and effect generation architecture 100 accesses a social network 150, such as social networking system 660 (FIG. 6) and/or social graph 700 (FIG. 7) to identify relevant posts from second users. The relevant posts may be identified as trending and/or relevant for a first user. The first user may be associated with a first user profile 110. Some examples may include a machine learning model to identify different posts relating to a same topic (event) and determine whether the first user would be interested in such an event. Furthermore, a machine learning model may categorize the event as one of the anticipated events 102, partially anticipated events 104 or unanticipated events 106.

Anticipated events 102 may be processed before the anticipated events 102 occurs. That is, the phrase and effect generation architecture 100 may process the anticipated events 102 prior to the anticipated events 102 occurring. The partially anticipated events 104 may be processed partially prior to the partially anticipated events 104 occurring, as the partially anticipated events 104 occurs and/or after the partially anticipated events 104 occurs with the phrase and effect generation architecture 100. The unanticipated events 106 may be processed as the unanticipated events 106 occurs or after the unanticipated events 106 occur.

The event filter 114 may filter the events 108 based on an interest level of the first user in the events 108. For example, not every one of the events 108 will be of interest to the first user. The first user has a user device 148 (e.g., a mobile device) used for communication. In order to spur relevant interactions with the social network 150, examples may partially auto-generate personalized, customized and relevant posts for the first user related to events. For example, some users may neglect to provide commentaries on current events due to the difficulty of articulating and identifying the wording of such commentaries. Furthermore, such commentaries may be haphazardly drafted by a user, lack personalized content as well as appear mundane. Thus, some examples may include an automated process to generate engaging phrases and content on behalf of the first user. Further, some examples may provide a prompt to a user in order to spur insightful and meaningful commentaries by the first user.

The event filter 114 may generate affinity scores 118. The affinity scores 118 may represent a strength of a relationship or level of interest between the first user and the events 108. For example, each respective affinity score of the affinity scores 118 may represent the specific level of interest that the first user has in a respective event of the events 108. Thus, each event of the events 108 has an affinity score of the affinity scores 118. If the respective affinity score meets a threshold, the respective event may be deemed to be of interest and the personalized phrase and effects process continues with the phrase and effect generation architecture 100. Otherwise, if the respective affinity score fails to meet the threshold, the respective event may be bypassed and is no longer processed with the phrase and effect generation architecture 100 to reduce resource consumption, bandwidth and processing power. Thus, events from the events 108 may be analyzed for relevance, and only relevant events may be processed.

In some examples, to determine relevant events from the events 108, the event filter 114 accesses second users profiles 116. The second users profiles 116 may be generated from the social network 150. For example, second users may access and interact with the social network 150 to execute actions on the social network 150, such as reading content, posting comments, liking posts, providing personal data (e.g., birthday, religion, age, demographic information, etc.). The social network 150 may track such interactions and store the interactions as part of the second users profiles 116. For example, each of the second users profiles may include interactions that a respective second user had with the social network 150.

In some examples, the social network 150 may include a multitude of user profiles. The multitude of user profiles may be filtered based on whether the multitude of user profiles are connected to the first user on the social network 150. For example, if a node of the social network 150, representing the first user and/or the first user profile 110, is connected by a friend-type edge to another node of the social network 150 representing another user and/or another user profile, the another user profile may be stored as one of the second user profiles 116. Furthermore, some examples may filter the profiles of the social network 150 to generate the second users profiles 116 based on other factors, such as one or more of whether demographic information of the first user profile 110 matches the demographics of profiles of the social network 150, whether location information of the first user profile 110 matches the location information of profiles of the social network 150, whether occupation information of the first user profile 110 matches the occupation information of profiles of the social network 150. If so, the profiles of the social network 150 may be stored as the second users profiles 116. Otherwise, the profiles of the social network 150 may be bypassed.

The event filter 114 may generate the affinity scores 118 based at least in part on the second users profiles 116. For example, if one or more of the second users profiles 116 indicates an interest in a particular event of the events 108, the affinity score of the affinity scores for that particular event may be increased. For example, the event filter 114 may adjust affinity scores 118 based on the notion that similar users may share similar interests. Thus, if friends of the first user indicate preferences for certain events of the events 108, such events may have elevated levels of interest for the first user. Thus, such events may have increased affinity scores 118.

In some examples, the affinity scores 118 may also be adjusted based on geographic locations. For example, an event may have more relevance for certain countries (e.g., Independence Day may be celebrated in United States but not in Canada). For example, Independence Day may have relevance for users associated with the Untied States. Thus, if a user is located in the United States, events involving Independence Day may be more relevant than for users residing outside of the United States, and the affinity scores 118 may be correspondingly adjusted. In some examples, preferred geographic locations of the first user profile 110 may also be indicative of interests. For example, if the first user profile 110 indicates that the first user is located in Canada but is a United States citizen, events involving Independence Day may be relevant for the first user, and the affinity scores 118 may be correspondingly adjusted. Thus, some examples identify that an event of the events 108 is associated with a geographic location, determine that the first user is associated with the geographic location, and determine that the event is to be presented to the user based on the first user and the event being associated with the geographic location.

The event filter 114 may further generate the affinity scores 118 based on the historical data 126 of the first user profile 110. For example, the first user profile 110 may include historical data 126 of the first user. The historical data 126 may include previous browsing history of the first user on the social network 150. The previous browsing history may be indicative of how the first user may interact with events 108. In some examples, interests 152 may be generated based on the historical data 126, or explicitly identified based on user input. For example, if the historical data 126 indicates that the first user views significant data related to a sports team, the sports team may be deemed to be an interest of the first user and added to the interests 152. Thus, trends indicated in the historical data 126 may be indicative of interests 152. For example, if the first user views significant content related to a topic (e.g., a number of articles viewed by the first user and related to the topic meets a threshold), the topic may be added to the interests 152.

The event filter 114 may generate the affinity scores 118 based on the interests 152. For example, if a respective event of the events 108 corresponds to an interest from the interests 152, an affinity score of the affinity scores 118 that is associated with the respective event may be increased. Thus, it is more likely that the event filter 114 will select events of the events 108 which correspond to the interest 152 and bypass events of the events 108 which do not correspond to interests 152.

In this example, the event filter 114 determines that only one affinity score of the affinity scores 118 meet the threshold. The one affinity score corresponds to a first event 120 from the events 108. It will be understood that the event filter 114 may output more than one event in some examples.

In order to generate meaningful interactions with the social network 150, an interaction generator 122 may determine a message 144 which will be provided to the first user. The message 144 includes the phrase 124 and the effect 142. The phrase 124 may include text to prompt the first user to comment on the first event 120, a reminder of previous posts by the first user which are relevant to the first event 120 or include text that the first user may post to social network 150.

In order to generate the phrase 124 and the effect 142, the interaction generator 122 may access the first user profile 110. A sentiment storage 134 includes information regarding a sentiment the first user may have toward the first event 120. The first user profile 110 may further include information that is indicative of how the first user would typically draft and post online to social network 150. That is, the interaction generator 122 will attempt to emulate the unique posting style (e.g., writing style and/or effect style) of the first user when generating the phrase 124 which may be a prompt, text to post to social network 150, etc.

The first user profile 110 includes several distinct features which are indicative of the first user's unique posting style. The first user profile 110 includes word storage 130 user syntax storage 128, lexicon storage 132 and sentiment storage 134. Lexicon storage 132 may store words that are uniquely used by the first user. A lexicon may be a collection of words used by people in a certain country or in a specific profession, hobby, or area of interest. For example, the first user may include unique terminologies including colloquialisms, idioms, jargons and/or slang in writings, videos, audio files and/or postings of the first user. Some examples identify such terminologies, identify a definition of such terminologies, and incorporate such terminologies when appropriate into the phrase 124. For example, if the first event 120 relates to soccer, terminologies such as slide tackle, shut out, strike, or dirty player may be appropriate to include into the phrase 124. Thus, terminologies related to the particular topic of the first event 120 may be selected from the lexicon storage 132 and incorporated as needed. Doing so enables the first user to feel familiarity with the phrase 124 and accordingly more willing to interact with the phrase 124.

The word storage 130 includes words that the first user frequently utilizes (e.g., in posts, comments, messages, audio streams, videos, etc.). For example, some examples identify a frequency of a word. If the frequency meets a threshold, the word may be added into the word storage 130. Otherwise if the frequency fails to meet the threshold, the word will not be stored in the word storage 130. The frequency may be a total number of times that first user utilizes the word, and/or a rate that the word occurs in a sample of words. For example, if a first word is identified as occurring one-hundred times out of a sample of two-thousand words, the first word would be added to the word storage 130.

User syntax storage 128 includes rules which define how the first user typically forms words and phrases to create a sentence. For example, users may adopt different styles of speaking and writing. In order to match the first user's unique style, examples analyze the historical data 126 to determine how the first user composes sentences. For example, some examples identify whether the first user includes unique sentence structures and emulates such unique sentence structures when generating the phrase 124.

The first user profile 110 further includes sentiment storage 134. The sentiment storage 134 may include sentiments that the first user associates with one or more items (e.g., certain events, places, people, activities, hobbies, movies, shows, etc.). That is, each sentiment of the sentiment storage 134 may be associated with one or more items. If the first event 120 is identified as being associated with one item of the items, a corresponding sentiment associated with the one item may be identified. In some examples, the first event 120 may be the item, or in a same category of the item (e.g., sports category). The interaction generator 122 generates the phrase 124 based on the corresponding sentiment. For example a positive or negative framing to the phrase 124 may be adopted based on whether the corresponding sentiment is positive or negative. As one detailed example, if the sentiment is positive, a positive prompt may be generated indicating that the first event 120 is a positive occurrence. If the sentiment is negative, a negative prompt may be generated indicating that the first event 120 is a negative occurrence.

Furthermore, the effect 142 may be selected based at least on the interests 152, historical data 126 and/or sentiment storage 134. For example, the effect 142 may be an audio recording (e.g., music, actor speaking, etc.), standard image, Graphics Interchange Format image, video, meme, etc. In order to select the effect 142, some examples may analyze the historical data 126 to determine which effects were previously utilized by the first user. Previously utilized effects may be more likely to be set as the effect 142. The effect 142 may also be selected based on the interests 152. For example, a particular song may be set as the effect 142 based on the particular song being of interest to the first user as indicated in the interests 152. Similarly, an image of a certain actor may be set as the effect 142 based on the interests 152 indicating that the actor is of interest to the first user.

The effect 142 may also be selected based on sentiments of the sentiment storage 134. For example, if an item in the event is associated with a positive sentiment, an upbeat and lively effect 142 (e.g., a positive song) may be selected. In some examples, if the sentiment indicates that the first event 120 relates to a match of the first user's favorite football team, a sentiment may be adjusted based on whether the first event 120 indicates that the football team won or lost. Thus, even though the football team is favored by the first user, the sentiment that the first user has towards the first event 120 will be dependent on the outcome of the first event 120. Therefore, the interaction generator 122 may identify an appropriate sentiment that the first user has towards the first event 120 based on characteristics of the first event 120, and in some cases, the outcome of the first event 120.

In some examples, the effect 142 may be selected based on a ranking of previously presented effects. Some examples may track which effects are most commonly selected by users (e.g., identifies a trending effect) and present such effects more frequently for presentation to other users. Thus, the effect 142 may be selected from a plurality of effects based on the effect 142 having a frequency that meets a trending threshold, and/or the frequency being greater than other frequencies of the plurality of effects.

The phrase 124 and the effect 142 may be transmitted to a user device 148 of the first user. For example the message 144 may be transmitted over a wireless network, the internet, etc. to the user device 148. The user device 148 may be under the direct control of the first user. A mobile application 140 is displayed on the user device 148. The mobile application 140 may be associated with the social network 150 and receive data from and transmit data to the social network 150. The data received from the social network 150 may be displayed in the mobile application 140. In this example, the phrase 124 is displayed in conjunction with the effect 142, the first event 120 and/or a representation of the first event 120 on the mobile application 140.

The first user may be able to modify the phrase 124 and/or the effect 142 through the mobile application 140. For example, the first user may modify the wording of the phrase 124, and/or adjust a size or sound of the effect 142. In some examples, the phrase 124 may be a prompt to cause the first user to draft a post. For example, the phrase 124 may ask the first user to “create a story for Mother's day” along with the effect 142 (e.g., a Mother's Day song). The modified phrase 124 and/or modified effect 142 may be provided to the social network 150 for publication. In some examples, the effect 142 may be bypassed such that only the modified phrase is published.

In some examples, a “midcard” may be used to bring awareness of trending topics across reels and stories and may include the phrase 124, the effect 142 and/or the first event 120 described above. A midcard may be an image(s) that is displayed in conjunction with another type of presentation (e.g., a video, reel, etc.) on the mobile application 140 and has one or more trending topics along with examples of reels and/or stories made around the one or more trending topics. Identification of whether the stories and/or reels is related to the topic may aid in identifying click-through rates. Furthermore, creation tiles on stories/reels may illustrate trending topic (e.g., instead of stating “create a story” examples may state “create a story around independence day,” “create a story around mother's day,” etc.).

Therefore, examples as described above may facilitate user engagement with social network 150 in an expedient and resource efficient manner. Doing so enhances user interaction with the social network 150 and generates a more vibrant environment in the social network 150. Conventional examples may simply generate a prompt to encourage interaction and posting. Such prompts are generic at best often times fail to arouse a user's interest. Generating and providing such prompts is wasteful and fails to provide any meaningful result of increasing and enhance user engagement. Thus, some examples generate personalized prompts that arouse user's interest and facilitate meaningful interactions and commentaries.

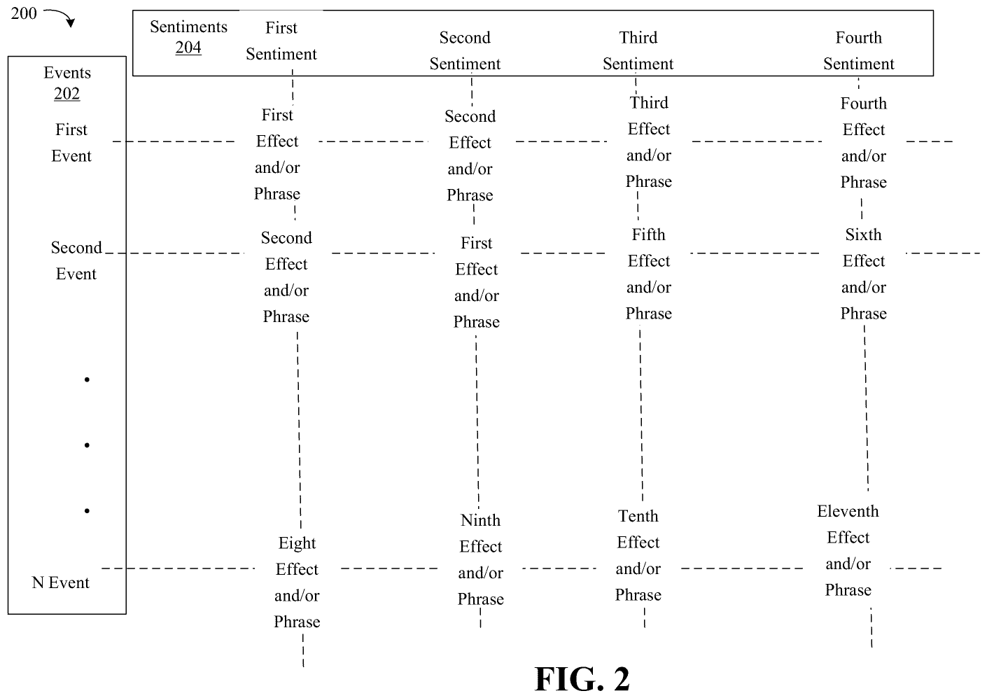

FIG. 2 illustrates a pre-generated phrase and event database 200. The pre-generated phrase and event database 200 may generally be implemented with the examples described herein, for example, the phrase and effect generation architecture (FIG. 1) already discussed. The pre-generated phrase and event database 200 may be stored in a storage (e.g., hard-drive, solid state drive, memory, etc.).

The pre-generated phrase and event database 200 may be applicable to anticipated events and/or partially anticipated events. The pre-generated phrase and event database 200 may be generated during off-peak time periods to reduce costs on power as well as to ensure that computing resources are available.

The phrases and effects of the pre-generated phrase and event database 200 may be generated before the events 202 are completed. An intersection between the events 202 and the sentiments 204 represents a different effect and/or phrase that is provided when different events and sentiments occur. For example, the first event may be a partially anticipated event such as a football game where a first team plays a second team. A first sentiment may be associated with sadness if the first team loses. Thus, if the first team loses at the completion of the first event, and a user's favorite team is the first team, the first effect and/or phrase may be provided to the user with low latency. A second sentiment may be associated with happiness if the first team wins. Thus, if the first team wins at the completion of the first event, and a user's favorite team is the first team, the second effect and/or phrase may be provided to the user with low latency.

Providing effects and/or phrases rapidly during and/or after an event increases user engagement. That is, doing so may increase interest in posting about events. For example, a significant amount of time may elapse between the completion of the events and providing phrases and/or events if examples waited until the events are completed to generate and provide the effects and/or phrases. Such a significant amount of time may reduce the level of interest that the users may have in posting on the first event. Thus, examples reduce such timing by pre-generating comments and/or phrases for different possible scenarios. Examples further provide such comments and/or phrases when the scenarios actually occur while discarding comments and/or phrases for scenarios that do not occur.

Notably, the first effect and/or phrase as well as the second effect and/or phrase may be reused across different users in some examples to reduce computing power and resources. Further, the first effect and/or phrase as well as the second effect and/or phrase may be reused across different events (e.g., the first event and second event) in some examples to reduce computing power and resources.

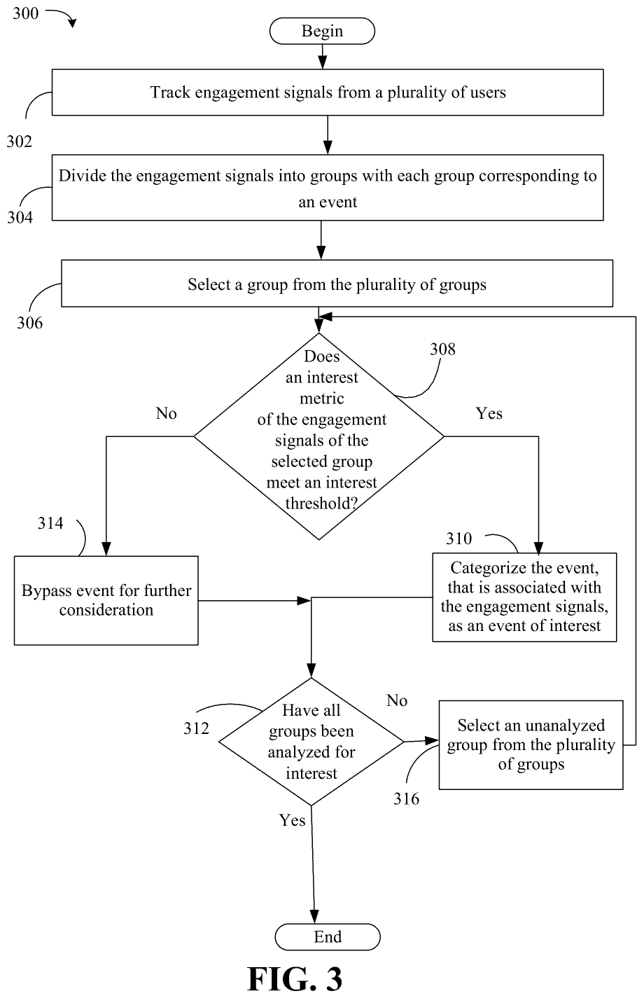

FIG. 3 illustrates a method 300 of identifying events of interest. One or more aspects of method 300 may be implemented as part of and/or in conjunction with the phrase and effect generation architecture (FIG. 1) and/or pre-generated phrase and event database 200 (FIG. 2) already discussed. Method 300 may be implemented in a computing device, computing system (e.g., hardware, configurable logic, fixed-function logic hardware, at least one computer readable storage medium comprising a set of instructions for execution, etc.). In some examples, the method 300 may at least be partially implemented with a machine learning model.

Illustrated processing block 302 tracks engagement signals from a plurality of users. The engagements signals may represent how users are interacting with online content. Thus, the engagement signals may track interactions of the users (e.g., a plurality of second users) with a social network that hosts the online content. Illustrated processing block 304 divides the engagement signals into groups with each group corresponding to an event. For example, each group may correspond to a single distinct and unique event. Illustrated processing block 306 selects a group from the plurality of groups.

Illustrated processing block 308 determines if an interest metric of the engagement signals of the selected group meet an interest threshold. For example, if the engagement signals indicate a sufficiently high level of interest in the event associated with the group, the engagement signals may be deemed to meet the interest threshold. If so, illustrated processing block 310 categorizes the event, that is associated with the engagement signals, as an event of interest. Otherwise, illustrated processing block 314 bypasses the event for further consideration. Illustrated processing block 312 determines if all groups have been analyzed for interest. If not, illustrated processing block 316 selects an unanalyzed group from the plurality of groups, and processing block 308 executes. Otherwise, the method 300 may end and the events of interest may be output for further processing. For example, the events of interest may constitute the events 108 (FIG. 1) already discussed and processed accordingly.

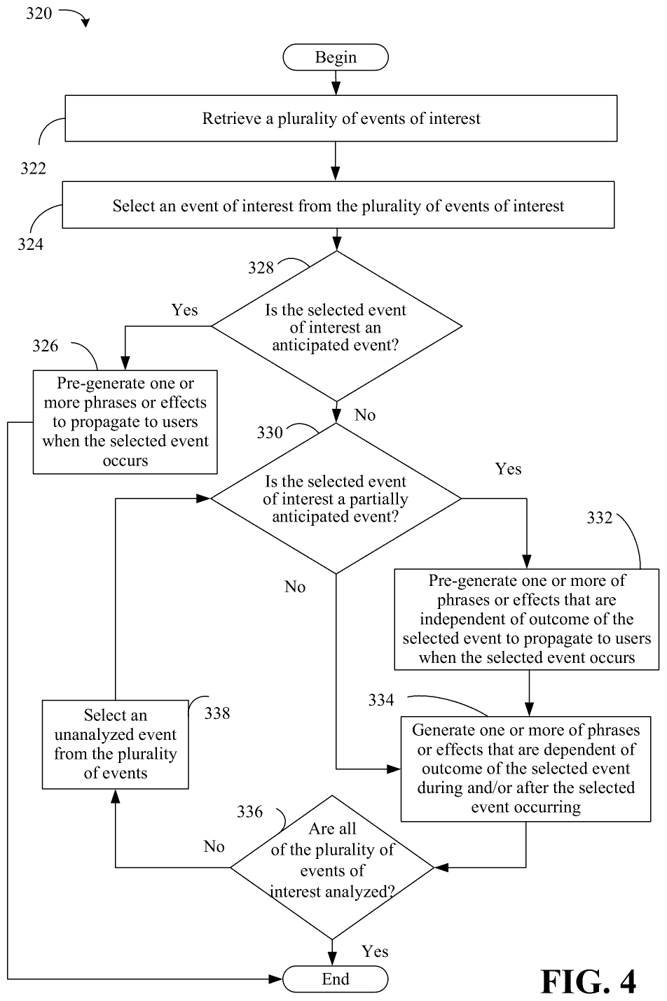

FIG. 4 illustrates a method 320 of generating phrases and effects based on whether an event is an anticipate event, partially anticipated event or unanticipated event. One or more aspects of method 300 may be implemented as part of and/or in conjunction with the phrase and effect generation architecture (FIG. 1) and/or pre-generated phrase and event database 200 (FIG. 2) and/or method 300 (FIG. 3) already discussed. Method 320 may be implemented in a computing device, computing system (e.g., hardware, configurable logic, fixed-function logic hardware, at least one computer readable storage medium comprising a set of instructions for execution, etc.).

Illustrated processing block 322 retrieves a plurality of events of interest. For example, the events of interest may be generated according to method 300 (FIG. 3) already discussed. Illustrated processing block 324 selects an event of interest from the plurality of events of interest. Illustrated processing block 328 determines if the selected event of interest is an anticipated event. An anticipated event may include a national holidays, festival, special occasion, etc. whose dates and outcomes are already known in advance. If so, illustrated processing block 326 pre-generates one or more phrases or effects to propagate to users when the selected event occurs. Processing block 326 may for example generate the pre-generated phrase and/or event database 200 (FIG. 2) already discussed.

Otherwise, illustrated processing block 330 determines if the selected event of interest is a partially anticipated event. A partially anticipated event includes an event that has a fixed date and time, but the outcome is unknown. If the selected event is a partially anticipated event, illustrated processing block 332 pre-generates one or more of phrases or effects that are independent of outcome of the selected event to propagate to users when the selected event occurs (i.e., prior to the event occurring). Illustrated processing block 334 also generates one or more of phrases or effects that are dependent of outcome of the selected event during and/or after the selected event occurring. In some examples, processing blocks 332, 334 may be modified to pre-generate phrases and/or effects for different outcomes prior to the event occurring (e.g., pre-generate phases and/or effects that are dependent on the outcome of the selected event), and providing only the phases and/or effects for scenarios that actually occur while discarding the other phrases and/or effects. Doing so may reduce the latency to provide the phrases and/or effects at a cost to resource consumption to generate unused phrases and/or effects.

If the selected event is determined to not be a partially anticipated event at processing block 330, then the selected event is presumed to be an unanticipated event. An unanticipated event occurs without any notice. Thus, processing block 334 executes if the event is an unanticipated event to generate one or more of phrases or effects that are dependent of outcome of the selected event during and/or after the selected event occurring (bypasses pre-generation of events).

Illustrated processing block 336 determines if all of the plurality of events of interest are analyzed. If not, illustrated processing block 338 selects an unanalyzed event from the plurality of events and processing block 330 executes. Otherwise, the method 320 ends.

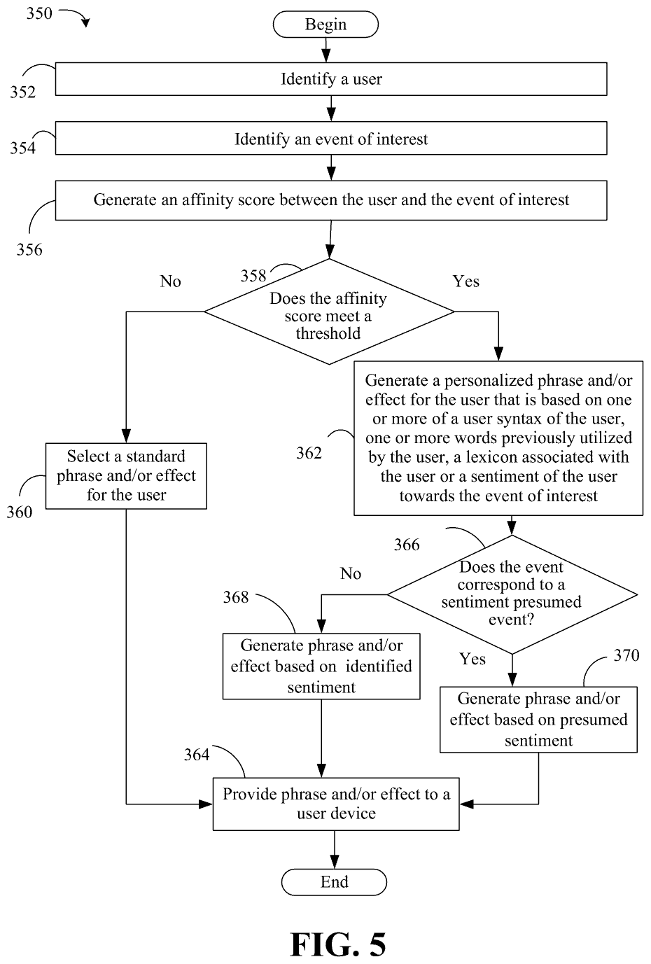

FIG. 5 illustrates a method 350 of determining whether to generate personalized comments based on an affinity score. One or more aspects of method 350 may be implemented as part of and/or in conjunction with the phrase and effect generation architecture (FIG. 1) and/or pre-generated phrase and event database 200 (FIG. 2), method 300 (FIG. 3) and/or method 320 (FIG. 4) already discussed. Method 320 may be implemented in a computing device, computing system (e.g., hardware, configurable logic, fixed-function logic hardware, at least one computer readable storage medium comprising a set of instructions for execution, etc.).

Illustrated processing block 352 identifies a user. Illustrated processing block 354 identifies an event of interest. Illustrated processing block 356 generates an affinity score between the user and the event of interest. Illustrated processing block 358 determines if the affinity score meets a threshold. If the affinity score does not meet the threshold, illustrated processing block 360 selects a standard phrase for the user. If the affinity score does meet the threshold, illustrated processing block 362 generates a personalized phrase and/or effect for the user that is based on one or more of a user syntax of the user, one or more words previously utilized by the user, a lexicon associated with the user or a sentiment of the user towards the event of interest.

Illustrated processing block 366 determines if the event corresponds to a sentiment presumed event. For example, some events may be so strongly associated with certain sentiments, a personalized sentiment of the user with the event of interest may not need to be determined. Rather, a generalized sentiment or presumed sentiment may be adopted. For example, generally most Americans will have positive and/or patriotic sentiments to the event Independence Day, thus the sentiment may be assumed to be positive or patriotic. In some examples, anticipated events always corresponds to a sentiment presumed event and are associated with a specific sentiment that is predicted ahead of time (e.g., prior to effects and/or phrases being generated).

If the event does not correspond to a sentiment presumed event, illustrated processing block 368 generates a phrase and/or effect based on an identified sentiment (e.g., determines a personalized sentiment that the user will have towards the event of interest). Otherwise, if the event of interest does not correspond to a sentiment presumed event, illustrated processing block 370 generates a phrase based on a presumed sentiment. Illustrated processing block 364 provides the phrase and/or effect to a user device.

FIG. 6 illustrates a method 380 of propagating user inputs to users. One or more aspects of method 350 may be implemented as part of and/or in conjunction with the phrase and effect generation architecture (FIG. 1), pre-generated phrase and event database 200 (FIG. 2), method 300 (FIG. 3), method 320 (FIG. 4) and/or method 350 (FIG. 5) already discussed. Method 380 may be implemented in a computing device, computing system (e.g., hardware, configurable logic, fixed-function logic hardware, at least one computer readable storage medium comprising a set of instructions for execution, etc.).

Illustrated processing block 382 receives a phrase and/or effect at a user device, where the phrase and/or effect are associated with an event. Illustrated processing block 384 displays the phrase and/or effect in a graphical user interface of the user device. Illustrated processing block 386 displays an image associated with event in the graphical user interface as well. Illustrated processing block 388 receives a user input via the graphical user interface. The user input may be an approval to publish the phrase and/or effect on behalf of the user to a social network. The user input may include a response to the phrase with a commentary related to the event (e.g., when the phrase is a prompt). Illustrated processing block 390 provides the user input, phrase and/or effect to a server for propagation to other users. For example, the server may host a social site, and propagate the user input to users of the social site (e.g., users connected to the user who provided the user input).

FIG. 7 illustrates a method 410 of determining when to generate personalized text and/or effect or bypass such actions. One or more aspects of method 410 may be implemented as part of and/or in conjunction with the phrase and effect generation architecture (FIG. 1), pre-generated phrase and event database 200 (FIG. 2), method 300 (FIG. 3), method 320 (FIG. 4), method 350 (FIG. 5) and/or method 380 (FIG. 6) already discussed. Method 410 may be implemented in a computing device, computing system (e.g., hardware, configurable logic, fixed-function logic hardware, at least one computer readable storage medium comprising a set of instructions for execution, etc.).

Illustrated processing block 412 identifies an event based on an affinity score of a user and the event. Illustrated processing block 414 identifies user sentiment for the event based on a user profile. Illustrated processing block 416 determines if the sentiment correspond to a generation criteria. A generation criteria indicates that a phrase and/or effect will likely cause the user to interact with and comment on the event. For example, the generation criteria may be that the sentiment should be a positive sentiment. Deeply negative sentiments (e.g., a funeral) may be avoided. In some examples, if the sentiment is only moderately positive or negative (e.g., evokes no passion from the user), the event may be bypassed from phase or sentiment generation such that illustrated processing block 420 executes. That is, illustrated processing block 420 bypasses generation of a phrase and/or sentiment. Otherwise, illustrated processing block 418 generates text of a phrase and/or effect based on the sentiment.

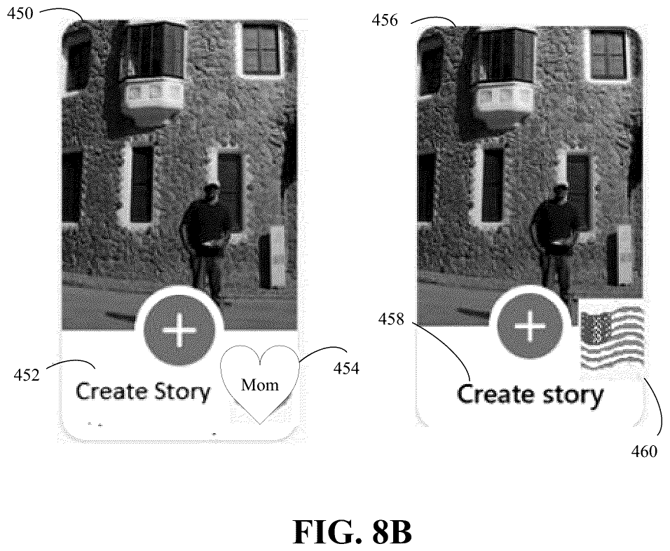

FIGS. 8A-8B illustrate a conventional graphical user interface 400 and enhanced graphical user interfaces 406, 410, 414. One or more aspects of the enhanced graphical user interfaces 406, 410, 414 may be implemented as part of and/or in conjunction with the phrase and effect generation architecture (FIG. 1), pre-generated phrase and event database 200 (FIG. 2), method 300 (FIG. 3), method 320 (FIG. 4), method 350 (FIG. 5), method 380 (FIG. 6) and/or method 410 (FIG. 7) already discussed.

In FIG. 8A, the conventional graphical user interface 400 includes a generic prompt “create story” 402 which lacks context, user engagement, originality and personalization. The enhanced graphical user interface 406 includes a personalized prompt 408 to spur a user to engage with the enhanced graphical user interface 406 and generate a post.

In FIG. 8B, enhanced graphical user interface 450 includes a generic prompt 452 with a personalized effect 454 (e.g., an image representing Mother's Day). Enhanced graphical user interface 456 includes a generic prompt 458 with a personalized effect 460 (e.g., an image representing Independent Day and is an American flag). It will be understood that other effects, such as audio, video, etc. may also be included. It will be further understood that a personalized prompt and effect may be provided.

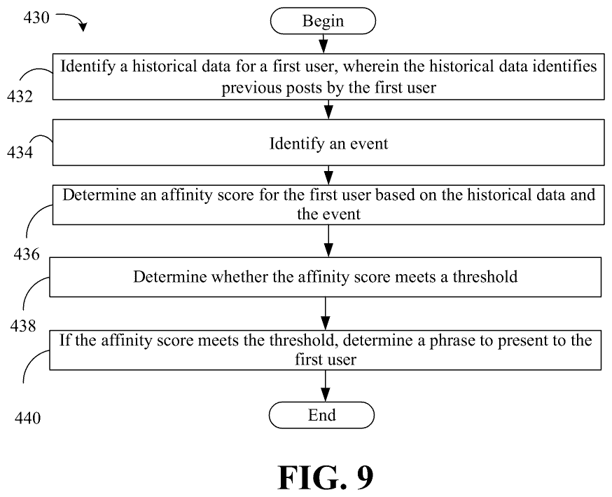

FIG. 9 illustrates a method 430 of generating phrases and/or effects. One or more aspects of method 430 may be implemented as part of and/or in conjunction with the phrase and effect generation architecture (FIG. 1), pre-generated phrase and event database 200 (FIG. 2), method 300 (FIG. 3), method 320 (FIG. 4), method 350 (FIG. 5), method 380 (FIG. 6), method 410 (FIG. 7), and/or enhanced graphical user interfaces 406, 452, 456 (FIGS. 8A-8B). Method 430 may be implemented in a computing device, computing system (e.g., hardware, configurable logic, fixed-function logic hardware, at least one computer readable storage medium comprising a set of instructions for execution, etc.).

Illustrated processing block 432 identifies a historical data for a first user, wherein the historical data identifies previous posts by the first user. Illustrated processing block 434 identifies an event. Illustrated processing block 436 determines an affinity score for the first user based on the historical data and the event. Illustrated processing block 438 determines whether the affinity score meets a threshold. If the affinity score meets the threshold, illustrated processing block 440 determine one or more of a phrase or an effect to present to the first user. In some examples, the method 430 includes identifying, with a machine learning model, the event based on interactions of a plurality of second users with a social network, wherein the interactions are associated with the event.

In some examples, the method 430 includes identifying one or more of a user syntax of the first user, one or more words previously utilized by the first user, a lexicon associated with the first user or a sentiment of the first user towards the event based on the historical record, and generating the phrase based on the one or more of the user syntax, the one or more words, the lexicon or the sentiment. In such examples, to generate the phrase based on the one or more of the user syntax, the one or more words, the lexicon or the sentiment, examples identify whether the phrase has a positive sentiment or a negative sentiment, and adjust the phrase based on whether the phrase has the positive sentiment or the negative sentiment.

In some examples, the method 430 includes identifying that the event is associated with a geographic location, determines that the user is associated with the geographic location, and determines that the event is to be presented based on the user being associated with the geographic location. In some examples, the method 430 includes identifying one or more effects to present to the first user based on the affinity score meeting the threshold, the event and the historical data. In some examples, the method 430 includes cause the one or more of the phrase or the effect to be displayed in a graphical user interface on a user device, where the graphical user interface is configured to receive an input from the first user to with an instruction to publish a post to a social network, wherein the post is associated with the one or more of the phrase or the effect.

System Overview

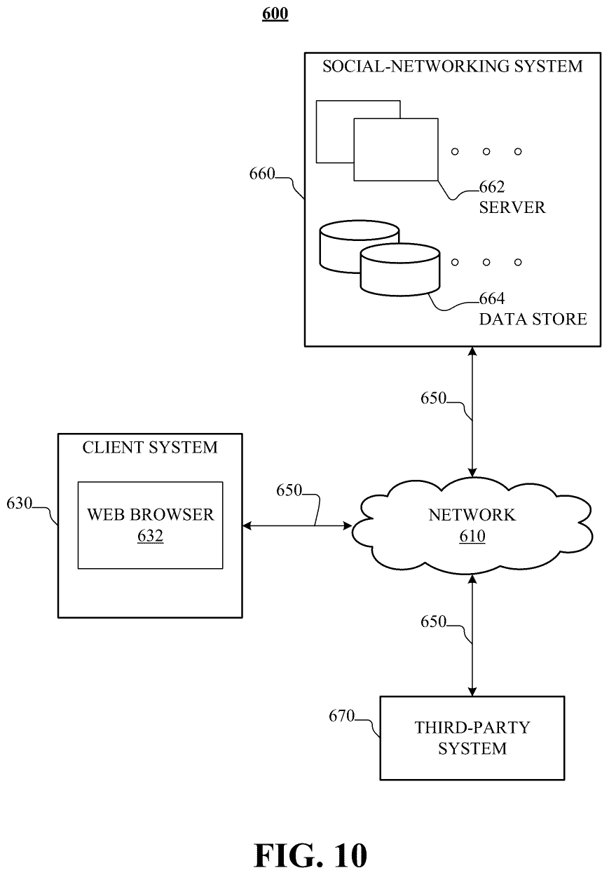

FIG. 10 illustrates an example network environment 600 associated with a social-networking system. Network environment 600 may implement one or more aspects of the phrase and effect generation architecture (FIG. 1), pre-generated phrase and event database 200 (FIG. 2), method 300 (FIG. 3), method 320 (FIG. 4), method 350 (FIG. 5), method 380 (FIG. 6), method 410 (FIG. 7), enhanced graphical user interfaces 406, 452, 456 (FIGS. 8A-8B), and/or method 430 (FIG. 9) already discussed.

Network environment 600 includes a client system 630, a social-networking system 660, and a third-party system 670 connected to each other by a network 610. Although FIG. 10 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 10 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular examples, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular examples, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular examples, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular examples, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular examples, each server 662 may include hardware, software, or embedded logic components or a combination of two or more such components for carrying out the appropriate functionalities implemented or supported by server 662. In particular examples, social-networking system 660 may include one or more data stores 664. Data stores 664 may be used to store various types of information. In particular examples, the information stored in data stores 664 may be organized according to specific data structures. In particular examples, each data store 664 may be a relational, columnar, correlation, or other suitable database. Although this disclosure describes or illustrates particular types of databases, this disclosure contemplates any suitable types of databases. Particular examples may provide interfaces that enable a client system 630, a social-networking system 660, or a third-party system 670 to manage, retrieve, modify, add, or delete, the information stored in data store 664.

In particular examples, social-networking system 660 may store one or more social graphs in one or more data stores 664. In particular examples, a social graph may include multiple nodes—which may include multiple user nodes (each corresponding to a particular user) or multiple concept nodes (each corresponding to a particular concept)— and multiple edges connecting the nodes. Social-networking system 660 may provide users of the online social network the ability to communicate and interact with other users. In particular examples, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular examples, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular examples, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular examples, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular examples, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular examples, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular examples, social-networking system 660 may include a variety of servers, sub-systems, programs, modules, logs, and data stores. In particular examples, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular examples, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

Social Graphs

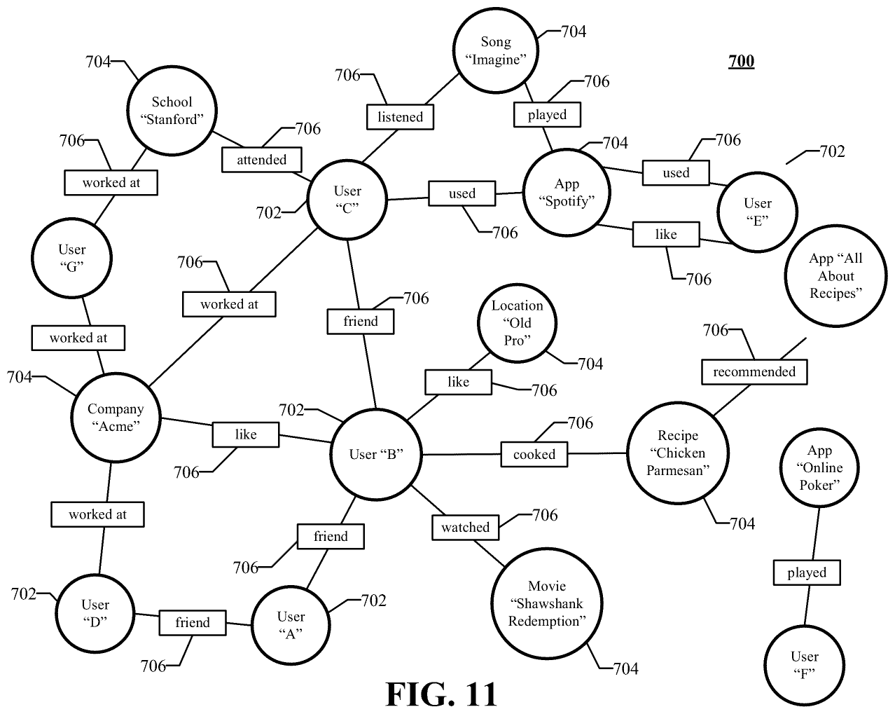

FIG. 11 illustrates example social graph 700. In some examples, the phrase and effect generation architecture (FIG. 1), pre-generated phrase and event database 200 (FIG. 2), method 300 (FIG. 3), method 320 (FIG. 4), method 350 (FIG. 5), method 380 (FIG. 6), method 410 (FIG. 7), enhanced graphical user interfaces 406, 452, 456 (FIGS. 8A-8B) and/or method 430 (FIG. 9) already discussed may access social graph 700 to implement one or more aspects.

In particular examples, social-networking system 660 may store one or more social graphs 700 in one or more data stores. In particular examples, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 11 is shown, for didactic purposes, in a two-dimensional visual map representation. In particular examples, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular examples, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular examples, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular examples, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular examples, a user node 702 may be associated with one or more data objects corresponding to information associated with a user. In particular examples, a user node 702 may correspond to one or more webpages.

In particular examples, a concept node 704 may correspond to a concept. As an example and not by way of limitation, a concept may correspond to a place (such as, for example, a movie theater, restaurant, landmark, or city); a web site (such as, for example, a web site associated with social-network system 660 or a third-party web site associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular examples, a concept node 704 may be associated with one or more data objects corresponding to information associated with concept node 704. In particular examples, a concept node 704 may correspond to one or more webpages.

In particular examples, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular examples, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular examples, a pair of nodes in social graph 700 may be connected to each other by one or more edges 706. An edge 706 connecting a pair of nodes may represent a relationship between the pair of nodes. In particular examples, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 11, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular examples, an edge 706 between a user node 702 and a concept node 704 may represent a particular action or activity performed by a user associated with user node 702 toward a concept associated with a concept node 704. As an example and not by way of limitation, as illustrated in FIG. 11, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 11) between user nodes 702 corresponding to the user and concept nodes 704 corresponding to the song and application to indicate that the user listened to the song and used the application. Moreover, social-networking system 660 may create a “played” edge 706 (as illustrated in FIG. 11) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 11 between user node 702 for user “E” and concept node 704 for “SPOTIFY”).

In particular examples, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular examples, social-networking system 660 may store an edge 706 in one or more data stores. In particular examples, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

Social Graph Affinity and Coefficient

In particular examples, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular examples, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular examples, social-networking system 660 may use a variety of factors to calculate a coefficient. These factors may include, for example, user actions, types of relationships between objects, location information, other suitable factors, or any combination thereof. In particular examples, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular examples, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular examples, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular examples, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular examples, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or more of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular examples, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular examples, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular examples, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular examples, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular examples, social-networking system 660 may calculate a coefficient based on location information. Objects that are geographically closer to each other may be considered to be more related or of more interest to each other than more distant objects. In particular examples, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular examples, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular examples, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular examples, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular examples, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular examples, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular examples may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

Privacy

In particular examples, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular examples, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular examples, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular examples, privacy settings may allow users to opt in or opt out of having their actions logged by social-networking system 660 or shared with other systems (e.g., third-party system 670). In particular examples, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular examples, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Systems and Methods

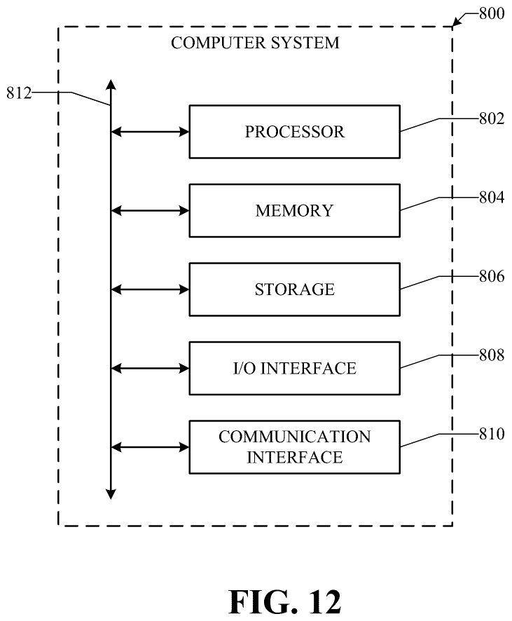

FIG. 12 illustrates an example computer system 800. The system 800 may implement one or more aspects of the phrase and effect generation architecture (FIG. 1), pre-generated phrase and event database 200 (FIG. 2), method 300 (FIG. 3), method 320 (FIG. 4), method 350 (FIG. 5), method 380 (FIG. 6), method 410 (FIG. 7), enhanced graphical user interfaces 406, 452, 456 (FIGS. 8A-8B) and/or method 430 (FIG. 9) already discussed. In particular examples, one or more computer systems 800 perform one or more steps of one or more methods described or illustrated herein. In particular examples, one or more computer systems 800 provide functionality described or illustrated herein. In particular examples, software running on one or more computer systems 800 performs one or more steps of one or more methods described or illustrated herein or provides functionality described or illustrated herein. Particular examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular examples, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular examples, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular examples, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular examples, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular examples, one or more memory management units (MMUs) reside between processor 802 and memory 804 and facilitate accesses to memory 804 requested by processor 802. In particular examples, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular examples, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular examples, storage 806 is non-volatile, solid-state memory. In particular examples, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular examples, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular examples, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular examples, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINTBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Thus, technology described herein may support a granular image enhancement selection process. The technology may substantially reduce the memory needed to store listings, the time needed to consummate a transaction and preserve valuable compute resources as well as bandwidth.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. At least one computer readable storage medium comprising a set of instructions, which when executed by a computing device, cause the computing device to:
identify a historical data for a first user, wherein the historical data identifies previous posts by the first user;
identify an event;
determine an affinity score for the first user based on the historical data and the event;
determine whether the affinity score meets a threshold; and
if the affinity score meets the threshold, determine one or more of a phrase or an effect to present to the first user.

2. The at least one computer readable storage medium of claim 1, wherein the instructions, when executed, cause the computing device to:
identify, with a machine learning model, the event based on interactions of a plurality of second users with a social network, wherein the interactions are associated with the event.

3. The at least one computer readable storage medium of claim 1, wherein the instructions, when executed, cause the computing device to:
identify one or more of a user syntax of the first user, one or more words previously utilized by the first user, a lexicon associated with the first user or a sentiment of the first user towards the event based on the historical record; and
generate the phrase based on the one or more of the user syntax, the one or more words, the lexicon or the sentiment.

4. The at least one computer readable storage medium of claim 3, wherein to generate the phrase based on the one or more of the user syntax, the one or more words, the lexicon or the sentiment, the instructions, when executed, cause the computing device to:
identify whether the phrase has a positive sentiment or a negative sentiment; and
adjust the phrase based on whether the phrase has the positive sentiment or the negative sentiment.

5. The at least one computer readable storage medium of claim 1, wherein the instructions, when executed, cause the computing device to:
identify that the event is associated with a geographic location;
determine that the first user is associated with the geographic location; and
determine that the event is to be presented based on the user being associated with the geographic location.

6. The at least one computer readable storage medium of claim 1, wherein the set of instructions, which when executed by the computing:
identify one or more effects to present to the first user based on the affinity score meeting the threshold, the event and the historical data.

7. The at least one computer readable storage medium of claim 1, wherein the set of instructions, which when executed by the computing:
cause the one or more of the phrase or the effect to be displayed in a graphical user interface on a user device, wherein the graphical user interface is configured to receive an input from the first user to with an instruction to publish a post to a social network, wherein the post is associated with the one or more of the phrase or the effect.

8. A system comprising:
one or more processors; and
a memory coupled to the one or more processors, the memory comprising instructions executable by the one or more processors, the one or more processors being operable when executing the instructions to:
identify a historical data for a first user, wherein the historical data identifies previous posts by the first user;
identify an event;
determine an affinity score for the first user based on the historical data and the event;
determine whether the affinity score meets a threshold; and
if the affinity score meets the threshold, determine one or more of a phrase or an effect to present to the first user.

9. The system of claim 8, wherein the one or more processors are further operable when executing the instructions to:
identify, with a machine learning model, the event based on interactions of a plurality of second users with a social network, wherein the interactions are associated with the event.

10. The system of claim 8, wherein the one or more processors are further operable when executing the instructions to:
identify one or more of a user syntax of the first user, one or more words previously utilized by the first user, a lexicon associated with the first user or a sentiment of the first user towards the event based on the historical data; and
generate the phrase based on the one or more of the user syntax, the one or more words, the lexicon or the sentiment.

11. The system of claim 10, wherein to generate the phrase based on the one or more of the user syntax, the one or more words, the lexicon or the sentiment, the one or more processors are further operable when executing the instructions to:
identify whether the event has a positive sentiment or a negative sentiment; and
adjust the phrase based on whether the event has the positive sentiment or the negative sentiment.

12. The system of claim 8, wherein the one or more processors are further operable when executing the instructions to:
identify that the event is associated with a geographic location;
determine that the first user is associated with the geographic location; and
determine that the event is to be presented based on the first user being associated with the geographic location.

13. The system of claim 8, wherein the one or more processors are further operable when executing the instructions to:
identify one or more effects to present to the first user based on the affinity score meeting the threshold, the event and the historical data.

14. The system of claim 8, wherein the one or more processors are further operable when executing the instructions to:
cause the one or more of the phrase or the effect to be displayed in a graphical user interface on a user device, wherein the graphical user interface is configured to receive an input from the first user with an instruction to publish a post to a social network, wherein the post is associated with the one or more of the phrase or the effect.

15. A method comprising:
identifying a historical data for a first user, wherein the historical data identifies previous posts by the first user;
identifying an event;
determining an affinity score for the first user based on the historical data and the event;
determining whether the affinity score meets a threshold; and
if the affinity score meets the threshold, determining one or more of a phrase or an effect to present to the first user.

16. The method of claim 15, further comprising:
identifying, with a machine learning model, the event based on interactions of a plurality of second users with a social network, wherein the interactions are associated with the event.

17. The method of claim 15, further comprising:
identifying one or more of a user syntax of the first user, one or more words previously utilized by the first user, a lexicon associated with the first user or a sentiment of the first user towards the event based on the historical data; and
generating the phrase based on the one or more of the user syntax, the one or more words, the lexicon or the sentiment.

18. The method of claim 17, wherein the identifying the one or more of the user syntax of the first user, the one or more words previously utilized by the first user, the lexicon associated with the first user or the sentiment of the first user towards the event based on the historical data further comprises:
identifying whether the event has a positive sentiment or a negative sentiment; and
adjusting the phrase based on whether the event has the positive sentiment or the negative sentiment.

19. The method of claim 15, further comprising:
identifying that the event is associated with a geographic location;
determining that the first user is associated with the geographic location; and
determining that the event is to be presented based on the first user being associated with the geographic location.

20. The method of claim 15, further comprising:
identifying one or more effects to present to the first user based on the affinity score meeting the threshold, the event and the historical data; and
causing the one or more of the phrase or the effect to be displayed in a graphical user interface on a user device, wherein the graphical user interface is configured to receive an input from the first user with an instruction to publish a post to a social network, wherein the post is associated with the one or more of the phrase or the effect.
